(19) United States
(12) Patent Application Publication
(10) Pub. No.: US 2025/0369459 A1
(43) Pub. Date: Dec. 4, 2025

(54) A PNEUMATIC SYSTEM FOR A VEHICLE

(71) Applicant: VOLVO TRUCK CORPORATION, Göteborg (SE)

(72) Inventor: Hugo BEBON, Saint Priest (FR)

(73) Assignee: VOLVO TRUCK CORPORATION, Göteborg (SE)

(21) Appl. No.: 19/203,454

(22) Filed: May 9, 2025

(30) Foreign Application Priority Data
May 28, 2024 (EP) 24178370.3

(51) Int. Cl. F15B 13/04; F15B 1/26; F15B 13/02; F16K 17/02

(52) U.S. Cl. CPC F15B 13/0401; F15B 1/26; F15B 13/027; F16K 17/02

(57) ABSTRACT

A pneumatic system for a vehicle has an air compressor for pressurizing an air tank. A flow passage extending from compressor is bifurcated to a first valve and to a second valve. The first valve has a first state preventing air from passing to the air tank, and has a second state allowing air to pass to the air tank. In a first mode of operation of the pneumatic system, the first vale is in said first state and the second valve controls air flow from the compressor to ambient environment. The second valve is configured to change to, or remain in, an open state when the pressure of the air upstream of the second valve is higher than a predetermined threshold, and to change to, or remain in, a closed state when the pressure of the air upstream of the second valve is lower than the predetermined threshold.

### TECHNICAL FIELD

The disclosure relates generally to a pneumatic system. In particular aspects, the disclosure relates to a pneumatic system for a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In existing pneumatic systems for vehicles, it is known to use a compressor to produce compressed air for braking, for pneumatic suspensions, and for pneumatic auxiliaries. It is also known to install an overflow valve just downstream of the outlet port of the compressor, in order to maintain the pressure at the compressor outlet. Because of the overflow valve, the pressure between the compressor and the overflow valve needs to reach the opening pressure of the overflow valve in order to open the overflow valve so that compressed air can be delivered to components further downstream. The opening pressure of the overflow valve is normally set by a spring. This leads to fixed opening pressure. This in turn means that whatever system pressure is present downstream of the overflow valve, the minimal compressor working pressure is the opening pressure of the overflow valve. In some cases the system pressure is lower than said opening pressure, which means that the compressor runs at a pressure which is higher than what is needed by the system. This leads to energy waste.

### SUMMARY

According to a first aspect of the disclosure, there is provided a pneumatic system for a vehicle, comprising:
an air tank,
a first valve,
a second valve, and
an air compressor configured to provide air from an output of the air compressor for pressurizing the air tank, wherein a flow passage extending from the output of the air compressor is bifurcated such that a first branch of the flow passage extends to the first valve and a second branch of the flow passage extends to the second valve,
wherein the first valve is configured to control air flow from the output of the air compressor to the air tank, wherein the first valve has a first state in which air is prevented from passing from the output of the air compressor to the air tank via the first valve, and has a second state in which air is allowed to pass from the output of the air compressor to the air tank via the first valve,
wherein the pneumatic system is operable in a first mode of operation in which the first valve is in said first state,
wherein, in said first mode of operation of the pneumatic system, the second valve is configured to control air flow from the output of the air compressor to ambient environment, the second valve having a closed state in which air is prevented from passing from the output of the air compressor to the ambient environment via the second valve, and an open state in which air is allowed to pass from the output of the air compressor to the ambient environment via the second valve,
wherein the second valve is configured to change to, or remain in, said open state when the pressure of the air in said second branch is higher than a predetermined threshold, and to change to, or remain in, said closed state when the pressure of the air in the second branch is lower than the predetermined threshold. The first aspect of the disclosure may seek to avoid the compressor to run at higher pressure than what is really needed by the pneumatic system. A technical benefit may include that by providing a bifurcated flow passage as defined above, compressed air can go through the first valve to the air tank so that the compressor working pressure may be equal to the system pressure and so that there is substantially no energy waste, and when compressed air is no longer required to the air tank, the compressed air can be guided through the second valve (having an opening pressure, i.e. the predetermined threshold) in order to keep the pressure at the output of the air compressor. Hereby, the compressed air does not need to constantly force its way through the second valve and its predetermined threshold, and therefore energy waste may be avoided. It should be understood that when no more compressed air is required to the air tank, it may still be desirable to continue to run the compressor for thermal management (e.g. to reach an appropriate compressor internal temperature to evaporate water and avoid corrosion). Thus, the compressor may be continued to run and the compressed air may be discharged to the ambient environment. In this disclosure the terms “compressor” and “air compressor” are used interchangeably.

Optionally in some examples, including in at least one preferred example, the pneumatic system may be operable in a second mode of operation in which the first valve is in the second state and in which the air tank becomes loaded with pressurized air supplied from the output of the air compressor via the first valve. A technical benefit may include that due to the bifurcation of the flow passage from the output of the air compressor, in said second mode of operation, the compressed air does not need to overcome the predetermined threshold of the second valve, but may smoothly flow along the first branch and through the open first valve to the air tank. Thus, the air compressor does not need to run at an unnecessarily high pressure to supply compressed air to the air tank.

Optionally in some examples, including in at least one preferred example, the pneumatic system may further comprise a filter located downstream of the first valve such that in the second state of the first valve, air that passes from the output of the air compressor to the air tank via the first valve, also passes through the filter after it has passed through the first valve, before the air reaches the air tank. A technical benefit may include that compressed air that is supplied to the air tank via the first valve can be appropriately filtered, thereby reducing the risk of unwanted particles to reach the air tank. On the other hand, when discharging air to the ambient environment via the second valve, the filter can be bypassed thereby avoiding saturating the filter prematurely.

Optionally in some examples, including in at least one preferred example, the pneumatic system may be operable in a third mode of operation in which the first valve is in the first state and in which pressurized air from the air tank is provided to the filter to regenerate the filter. A technical benefit may include that by closing the first valve, air from the air tank can efficiently be provided through the filter in the reverse direction to regenerate the filter. The air and the particles that become released from the filter during the regeneration may be passed to the ambient environment. It should be understood that in the third mode of operation of the pneumatic system, the second valve may be in its closed state if the pressure of the air in said second branch is lower than the predetermined threshold or in its open state if the pressure of the air in said second branch is higher than the predetermined threshold. Thus, in the third mode of operation of the pneumatic system, the compressor may still be operated (for example, for compressor temperature management reasons).

Optionally in some examples, including in at least one preferred example, the pneumatic system may further comprise:
a first energizable valve device,
a second energizable valve device, and
processing circuitry configured to set a current mode of operation of the pneumatic system by selectively energizing the first and second valve devices. A technical benefit may include that using energizable valve devices, provides an efficient control of different modes of operation of the pneumatic system. Some examples of such control will be discussed below.

Optionally in some examples, including in at least one preferred example, the air tank may have a cut-off pressure, wherein when the air pressure in the air tank reaches the cut-off pressure, the processing circuitry may energize the first energizable valve device, thereby allowing pressurized air that is present in a volume between the air tank and the first energizable valve device to pass through the first energizable valve device and reach the first valve so as to pneumatically activate the first valve to change to its first state. A technical benefit may include that in this way, the first valve may be changed to its first state in a timely manner, thereby avoiding providing compressed air to the air tank when no longer required. Suitably, there may be provided a pressure sensor at the air tank, which pressure sensor may be operatively connected to the processing circuitry. The processing circuitry may include a single control unit (or processor device) or a plurality of control units (or processor devices) connected or otherwise communicatively coupled to each other, such that any performed function may be distributed between the control units (processor devices) as desired. Further, such devices may communicate with each other or other devices by various system architectures, such as directly or via a Controller Area Network (CAN) bus, etc.

Optionally in some examples, including in at least one preferred example, in order to set the pneumatic system in said third mode of operation, the processing circuitry may be configured to energize the second energizable valve device, thereby allowing pressurized air that is present in a volume between the air tank and the second energizable valve device to pass through the second energizable valve device and reach the filter so as to regenerate the filter in said third mode of operation. A technical benefit may include that filter regeneration may be efficiently controlled in this way. Thus, already pressurized air available downstream of the filter may be used for regenerating the filter.

Optionally in some examples, including in at least one preferred example, in order to set the pneumatic system in said third mode of operation, the processing circuitry may also be configured to energize the first energizable valve device to allow pressurized air to pass through the first energizable valve device to pneumatically activate the first valve to change to its first state. A technical benefit may include that by allowing the processing circuitry to control both the first and the second energizable valve, the pressurized air available downstream of the filter may be used in an efficient way to both out the first valve in its first state and to blow through the filter in the reverse direction. Because of the first valve being arranged in said first state, compressed air from the compressor is prevented from counteracting the flow of regenerative pressurized air.

Optionally in some examples, including in at least one preferred example, the first valve may comprise a first channel and a second channel, wherein in said first state of the first valve:
the first channel is closed to prevent air from passing from the output of the air compressor to the air tank via the first valve, and
the second channel is open to allow air that has passed from the output of the air compressor and through the second valve to then also pass through the second channel of the first valve before reaching the ambient environment. A technical benefit may include that, hereby, air coming through the second valve may automatically be guided to the ambient environment when the first valve is arranged in said first state.

Optionally in some examples, including in at least one preferred example, in said second state of the first valve:
the first channel is open to allow air to pass from the output of the air compressor, through the first channel of the first valve, to the air tank, and
the second channel is closed to prevent air from passing from the second valve, through the first valve, to the ambient environment. A technical benefit may include that, when the first valve is in its second state (allowing air to pass from the output of the air compressor to the air tank via the first channel of the first valve), then any compressed air passing through the second valve (assuming the pressure overcomes the predetermined threshold) may suitably also be guided to reach the air tank and not be wasted to the ambient environment (since the second channel is closed).

Optionally in some examples, including in at least one preferred example, the pneumatic system may further comprise a third valve arranged between the second valve and an outlet to the ambient environment, the third valve having an open state in which air from the second valve is allowed to flow through the third valve to the ambient environment, and a closed state in which air from the second valve is prevented from flowing through the third valve to the ambient environment, wherein, in said first mode of operation of the pneumatic system, the third valve is in its open state. A technical benefit may include that providing such a third valve allows more freedom of design, for example, with respect to how to draw tubing from the second valve to ambient environment, i.e. not being restricted to let the air pass via the first valve to the ambient environment.

Optionally in some examples, including in at least one preferred example, the air compressor may be an oil-lubricated air compressor. The teachings of the present disclosure may be particularly beneficial for oil-lubricated air compressors. In particular, in cases when it is desired to stop an oil-lubricated air compressor (e.g. air tank has reached its target pressure), the risk of a high pressure drop, and therefore the risk of high oil rejection, can be avoided. In particular, if the compressor is stopped, then the second valve will close when the pressure of the air flowing through the second valve falls below the predetermined threshold. Hereby, pressure between compressor and the second valve may be kept at a desired level, wherefore there will be no high pressure drop (which would otherwise be the case if the output of the air compressor would be allowed to remain in open communication with the ambient environment).

Optionally in some examples, including in at least one preferred example, the pneumatic system may further comprise an air dryer located downstream of the air compressor and upstream of the air tank, wherein the first valve and the second valve are integrated in the air dryer. A technical benefit may include that by integrating the first valve and the second valve in the air dryer, the function of a traditional overflow valve (which would normally be provided between the compressor and the air dryer) may now be assigned to the second valve, and that the second valve may be bypassed when it is not needed and instead the compressed air can pass smoothly through the first valve to the air tank.

Optionally in some examples, including in at least one preferred example, the pneumatic system may further comprise a bypass passage which allows for fluid communication between a first point and a second point, wherein the first point is located in an air passage between the first valve and the filter, and wherein the second point is located in an air passage between the second valve and the first valve. A technical benefit may include that when the filter is regenerated, air passing in the reverse direction through the filter may then be allowed to flow along said bypass passage (from the first point to the second point), which in turn may lead to the ambient environment via a channel in the first valve. When the first valve is in the second state allowing compressed air to be passed through the first valve to the air tank, then the bypass passage may suitably also allow any compressed air that has passed through the second valve to pass from the second point to the first point of the bypass passage, in order to contribute to the filling of the air tank.

Optionally in some examples, including in at least one preferred example, the first valve may be spring-biased towards the second state. A technical benefit may include that hereby the first valve is normally in an operating condition in which it allows air to be supplied from the compressor to the air tank, and that the spring force needs to be overcome in order to move the first valve to its first state. As mentioned previously, this may suitably be effectuated when the air tank has reached a cut-off pressure, wherein excess air pressure may be used to move the first valve to its first state against the force of the spring bias.

Optionally in some examples, including in at least one preferred example, the second valve may be spring-biased towards the closed state. A technical benefit may include that hereby, it may conveniently function similarly to an overflow valve, requiring the compressed air from the compressor to overcome the predetermined threshold caused by the spring force.

Optionally in some examples, including in at least one preferred example, the pneumatic system may further comprise a check-valve, wherein the filter is located between the first valve and the check-valve, wherein the check-valve allows air to flow from the filter through the check valve to the air tank, but prevents air flow in the opposite direction. A technical benefit may include that pressure in the air tank may be efficiently maintained, and unwanted backflow can be avoided when the compressor is stopped.

Optionally in some examples, including in at least one preferred example, said check-valve may be a first check-valve, wherein the pneumatic system may further comprise a second check-valve, wherein the second check-valve may be located in an air passage extending from the second energizable valve device to a point located between the filter and the first check-valve. A technical benefit may include that hereby the filter can be effectively regenerated, and unwanted backflow to the second energizable valve can be avoided.

Optionally in some examples, including in at least one preferred example, the pneumatic system may further comprise:
a first air passage extending from the output of the air compressor to the first valve,
a second air passage extending from the first valve to the air tank,
a third air passage extending from the output of the air compressor to the second valve,
a fourth air passage extending from the second valve to the first valve,
a fifth air passage extending from the first valve to the ambient environment,
wherein pressurized air passes said first air passage and said second air passage on its way from the output of the compressor to the air tank, and wherein air passes said fourth air passage and said fifth air passage on its way from the second valve to the ambient environment. A technical benefit may include that hereby you can avoid the compressor to run at higher pressure that what is really needed by the pneumatic system.

According to a second aspect of the disclosure, there is provided a vehicle comprising the pneumatic system according to the first aspect, including any examples thereof. The second aspect of the disclosure may seek to solve corresponding problem and provide similar technical benefits as the first aspect, including any examples thereof.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an illustration of a vehicle according to at least one example of this disclosure.

FIG. 2 is a schematic illustration of a prior art pneumatic system.

FIG. 3 is a schematic illustration of a pneumatic system according to at least one example of this disclosure.

FIGS. 4-7 illustrate schematically a pneumatic system according to at least one example of this disclosure; wherein different operating modes of the pneumatic system are illustrated.

FIGS. 8-11 illustrate schematically a pneumatic system according to at least another example of this disclosure; wherein different operating modes of the pneumatic system are illustrated.

FIG. 12 is a further schematic illustration of a pneumatic system according to at least one example of this disclosure.

### DETAILED DESCRIPTION

The detailed description set forth below provides information and examples of the disclosed technology with sufficient detail to enable those skilled in the art to practice the disclosure.

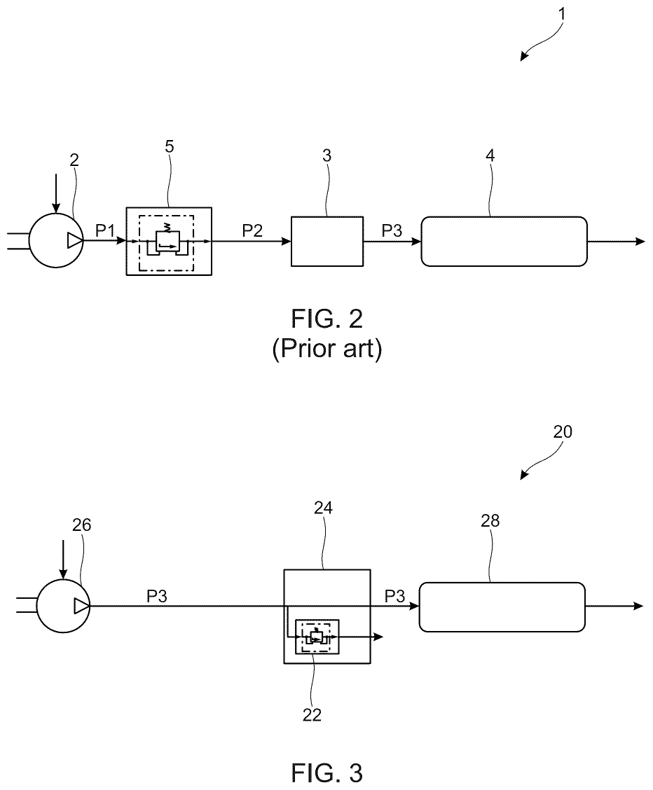

A prior art pneumatic system 1 is schematically illustrated in FIG. 2A compressor 2 produces compressed air which is passed through an air dryer 3 to an air tank 4 from which the pressurized air may be supplied to different vehicle components, such as brakes, suspensions, auxiliaries, etc. An overflow valve 5 is provided between the compressor 2 and the air dryer 3. When the air dryer 3 is operated to discharge air to ambient atmosphere, instead of air being supplied to the air tank 4, the presence of the overflow valve 5 is beneficial to avoid the risk of sudden pressure drops at the output of the compressor 2 However, when it is desired to supply pressurized air to the air tank 4, then the presence of the overflow valve 5 may present a hurdle. The pressure between the compressor 2 and the overflow valve 5 needs to reach the opening pressure of the overflow valve 5 so that compressed air can be delivered to the air tank 4. Thus, even though the system pressure is low downstream of the overflow valve 5, the compressor 2 will still need a working pressure which is at least equal to the opening pressure of the overflow valve 5. Therefore, in cases when the system pressure is lower than said opening pressure, the compressor 2 will be running at a pressure which is higher than what is needed by the system. In FIG. 2 the pressure is P1 in the line between the compressor 2 and the overflow valve 5; the pressure is P2 in the line between the overflow valve 5 and the air dryer 3; and the pressure is P3 after the air dryer 3 and also in the air tank 4 (system pressure). Thus, in the above-mentioned cases, when the compressor 2 runs at a pressure which is higher than what is needed by the system (P3), then P1>P3 This leads to energy waste.

According to the present disclosure such energy wasting may be avoided by providing a valve which has a functionality similar to the above exemplified overflow valve, i.e. allowing pressure at the compressor output to be maintained when needed, but which valve may be bypassed when its functionality is not needed. In particular, when the system pressure is low, such a valve may be bypassed so that air can still be provided to the air tank even though the compressor is running at a pressure which is lower than the opening pressure of that valve.

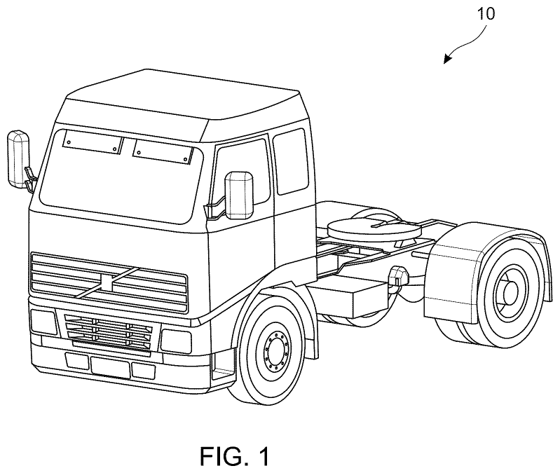

FIG. 1 is an illustration of a vehicle 10 according to at least one example of this disclosure. More specifically, the illustrated vehicle 10 is a heavy-duty vehicle in the form of a tractor unit, which may be configured to pull a trailer unit. However, the teachings of the present disclosure may be implemented for other types of vehicles as well. The vehicle 10 may be a driver-operated vehicle or a self-driving autonomous vehicle. The vehicle 10 may comprise a pneumatic system in accordance with any example of this disclosure, including the examples which will be discussed below with reference to FIGS. 3-12.

FIG. 3 is a schematic illustration of a pneumatic system 20 according to at least one example of this disclosure. In particular, FIG. 3 is a very general illustration of an exemplary implementation of the teachings of this disclosure. In this example, an overflow valve 22 has instead been illustrated as being integrated in the air dryer 24, and that discharging air to the ambient environment may be done via the overflow valve 22 As is also illustrated in FIG. 3, in order for the compressor 26 to supply compressed air to the air tank 28, there is no need to pass through the overflow valve 22. Thus, the pressure in the line between the compressor 26 and the air dryer 24 may be held at the same pressure (P3) as the pressure in the air tank 28. Hereby, energy waste may be avoided. As mentioned above, FIG. 3 illustrates that an overflow valve 22 is integrated in the air dryer 24. This may be a practical configuration as bulkiness of tubes/pipes etc. may be reduced, keeping a plurality of components in one common housing. Nevertheless, it should be understood that the bypassing may be achieved even if the overflow valve 22 is provided outside of the air dryer 24. Thus, according to some examples, the overflow valve 22 may be a separate component from the air dryer 24.

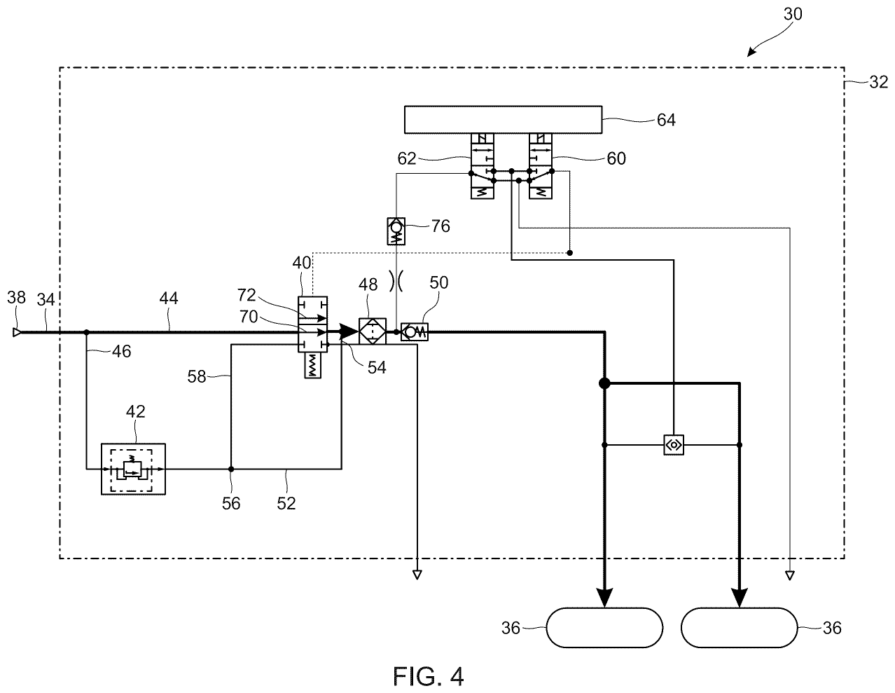

More detailed examples of a pneumatic system of this disclosure will now be discussed with respect to FIGS. 4-7 and FIGS. 8-11. In these drawing figures, reference will be made to a “second valve”, which may have similar functionality to the overflow valve mentioned in FIG. 3. It should, however, be understood that although these drawing figures illustrate that the second valve is integrated into the air dryer, in other examples the second valve may be provided outside the air dryer. Furthermore, although these drawings illustrate two air tanks that may receive compressed air from the air compressor, the teachings of this disclosure are not limited to a specific number of air tanks. Thus, the pneumatic system may include one, two, three or more air tanks to be provided with air from an air compressor.

FIGS. 4-7 illustrate schematically a pneumatic system 30 according to at least one example of this disclosure; wherein different operating modes of the pneumatic system 30 are illustrated.

Starting with FIG. 4, in this example, the pneumatic system 30 comprises an air dryer 32 which is schematically illustrated by the large dashed rectangle. A flow passage 34 is illustrated to extend from the outside of the air dryer 32 and into the air dryer 32. The flow passage 34 extends from an output 38 of an air compressor (not shown in FIGS. 4-7), such as any one of the previously discussed air compressors. Compressed air may thus be delivered from the output 38 of the air compressor into the air dryer 32 in order to pressurize an air tank 36 (in FIG. 4 two air tanks 36 can be pressurized). The air tanks 36 are provided in fluid communication with respective outlets of the air dryer 32. The air compressor and the air tanks 36 are included in the pneumatic system 30.

The pneumatic system 30 further comprises a first valve 40 and a second valve 42. The flow passage 34 that extends from the output of the air compressor is bifurcated such that a first branch 44 of the flow passage 34 extends to the first valve 40 and a second branch 46 of the flow passage 34 extends to the second valve 42. The first valve 40 is configured to control air flow from the output 38 of the air compressor to the air tanks 36. The first valve has a first state in which air is prevented from passing from the output 38 of the air compressor to the air tanks 36 via the first valve 40, and has a second state in which air is allowed to pass from the output 38 of the air compressor to the air tanks 36 via the first valve 40. In FIG. 4, the first valve 40 is in its second state. Thus, the first valve 40 is now positioned to allow air from the compressor to pass along the first branch 44 to and through the first valve 40. Downstream of the first valve 40, there may be provided a filter 48 for removing unwanted particles from the air stream and a first check-valve 50 for preventing backflow. Thus, FIG. 4 illustrates an operating mode in which the first valve 40 is in its second state and in which the air tanks 36 may become loaded with pressurized air supplied from the output 38 of the air compressor via the first valve 40 (and in this example also via the filter 48 and the first check-valve 50).

The second valve 42 shown in FIG. 4 has a closed state in which air cannot pass through the second valve 42 and an open state in which air can pass through the second valve 42. The second valve 42 may suitably be spring-biased towards the closed state, in order to set an opening pressure threshold. The second valve 42 is configured to change to, or remain in, the open state when the pressure of the air in the second branch 46 is higher than a predetermined threshold. Conversely, the second valve 42 is configured to change to, or remain in, the closed state when the pressure of the air in the second branch 46 is lower than the predetermined threshold. Thus, the functionality of the second valve 42 may be an overflow valve or may be regarded to correspond to the functionality of an overflow valve. As can be seen in FIG. 4, the pneumatic system 30 may further comprise a bypass passage 52 which allows fluid communication between a first point 54 and a second point 56. The first point 54 is located in an air passage between the first valve 40 and the filter 48, and the second point 56 is located in an air passage 58 between the second valve 42 and the first valve 40. If the air compressor provides a pressure which is higher than said predetermined threshold, then the pressurized air will, in addition to passing through the first valve 40, also pass through the second valve 42 and via the bypass passage 52 to pressurize the air tanks 36. However, if pressure requirement is low (lower than said predetermined threshold of the second valve 42), then the second valve 42 may be bypassed and in such case the air from the compressor will only be delivered to the air tanks 36 via the first valve 40 since the second valve 42 remains closed.

FIG. 4 also shows that the pneumatic system 30 may further comprise a first energizable valve device 60, a second energizable valve device 62, and a processing circuitry 64 configured to set a current mode of operation of the pneumatic system 30 by selectively energizing the first and/or second energizable valve devices 60, 62. In FIG. 4, however, the energizable valve devices 60, 62 have not been energized. The energizable valve devices 60, 62 may, for instance, be magnet or solenoid valves.

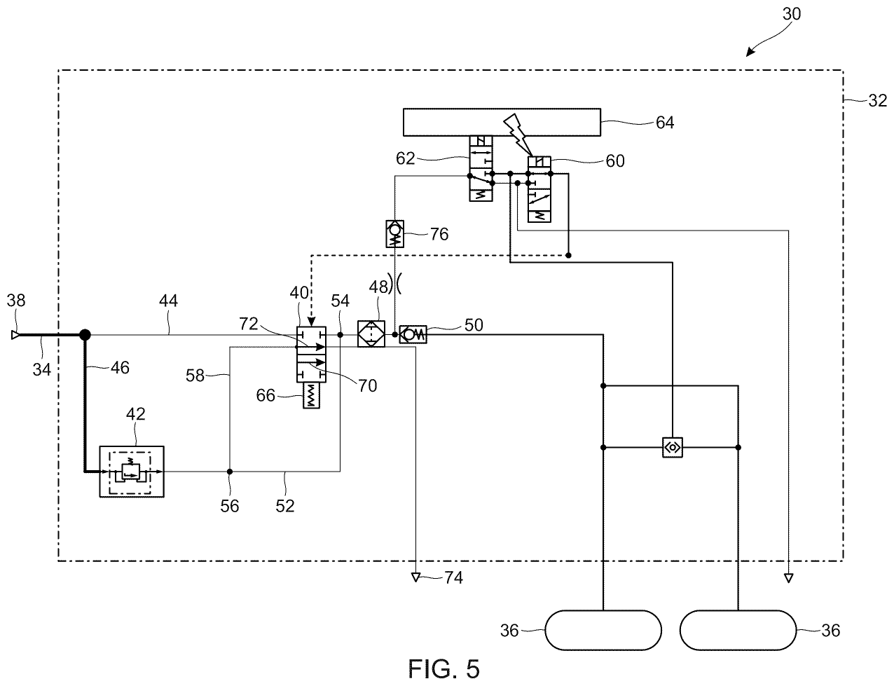

FIG. 5 illustrates that the first energizable valve device 60 has been energized. This may be the case when the air pressure in the air tanks 36 have reached a cut-off pressure. Suitably, there may be provided pressure sensors (not illustrated) at the outlets of the air dryer 32, wherein the pressure sensors may communicate the pressure level to the processing circuitry 64. Thus, when the processing circuitry 64 receives information that the air pressure in the air tanks 36 have reached the cut-off pressure, the processing circuitry 64 may operate so that the first energizable valve device 60 becomes energized. When the first energizable valve device 60 is energized it moves to a position in which it allows pressurized air that is present in a volume between the air tanks 36 and the first energizable valve device 60 to pass through the first energizable valve device 60 and reach the first valve 40 so as to pneumatically activate the first valve 40 to change to its first state. Indeed, as can be seen in FIG. 5, the first valve 40 is now in its first state instead of its second state shown in FIG. 4. As can be seen, the first valve 40 may suitably be spring biased towards the second state (see indicated spring 66). Thus, the pressurized air flowing through the first energizable valve device 60 must overcome the spring force so as to pneumatically actuate the first valve 40, i.e. to achieve the change from the second state to the first state of the first valve 40.

As can be seen in FIG. 5, the first valve 40 may comprise a first channel 70 and a second channel 72. In the illustrated first state of the first valve 40, the first channel 70 is closed to prevent air from passing from the output 38 of the air compressor to the air tanks 36 via the first valve 40. On the other hand, in the illustrated first state of the first valve 40, the second channel 72 is open to allow air to pass through the second channel 72 of the first valve and then reach the ambient environment via an exhaust port 74. In contrast, in FIG. 4, which illustrates the second state of the first valve 40, the first channel 70 is open to allow air to pass to the air tanks 36, while the second channel 72 is closed to prevent air from passing through the first valve 40 to the ambient environment.

Although FIG. 5 illustrates the first valve 40 in its first state, wherein the second channel 72 would allow air to be discharged to the ambient environment, the pressure in the second branch 46 is in this illustration lower than the predetermined threshold of the second valve 42. Thus, the second valve 42 will be in its closed state. Thus, FIG. 5 may illustrate a mode of operation in with a cut-off pressure of the tanks 36 have been reached, and the compressor has stopped (for example because the right compressor temperature has already been reached and the compressor therefore does not need to continue running for corrosion avoidance purposes, etc.). Because the second valve 42 is closed and because the first channel 70 of the first valve 40 is closed, the pressure in the first and second branches 44, 46 and the flow passage 36 can be maintained. This is particularly advantageous in case of oil lubricated compressors, as this avoids a high pressure drop at the output 38 of the compressor and therefore avoids high oil rejection.

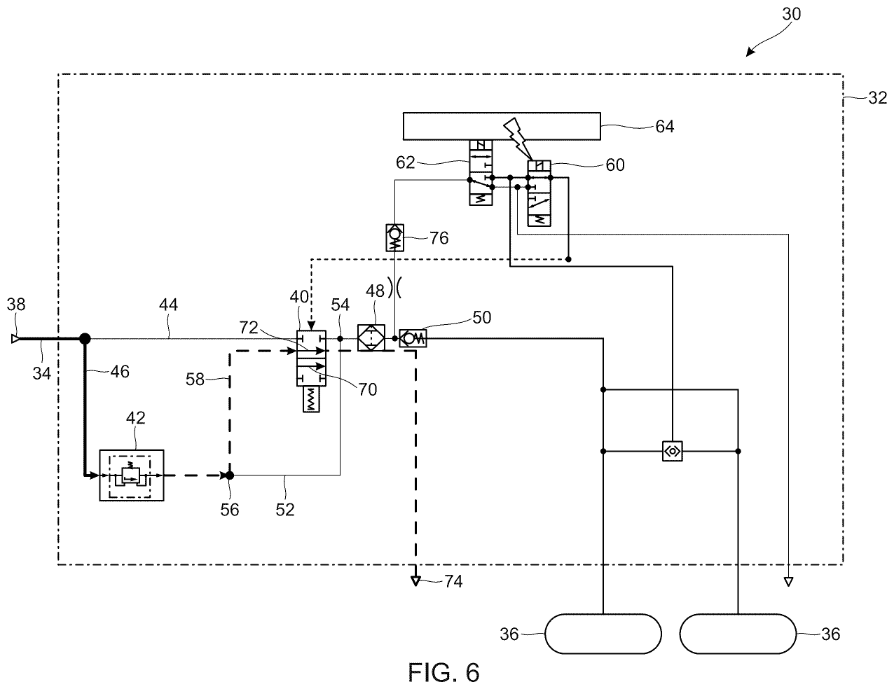

FIG. 6 illustrates, similarly to FIG. 5, that the first energizable valve device 40 has been energized. However, now the pneumatic system 30 is operated in a different mode of operation, in which the compressor continues to run for thermal management. The pressure in the second branch 46 becomes increased so that the second valve 42 is changed to its open state, wherein the compressed air is allowed to flow through the second valve 42. Since the second channel 72 of the first valve 40 is open and in communication with ambient environment through the exhaust port 74, there will be ambient pressure in the air passage 58 between the second valve 42 and the first valve 40. Thus, when second valve 42 becomes opened, the air flowing through the second valve 42 will choose the path with least resistance, i.e. it will continue to flow through the first valve 40 and then to the ambient environment. Thus, FIG. 6 illustrates that the pneumatic system 30 is operable in a first mode of operation in which the first valve 40 in the first state, and in that first mode of operation, the second valve 42 is configured to control air flow from the output 38 of the air compressor to ambient environment (the second valve 42 having a closed state in which air is prevented from passing via the second valve 42 to the ambient environment and an open state in which air allowed to pass via the second valve 42 to the ambient environment).

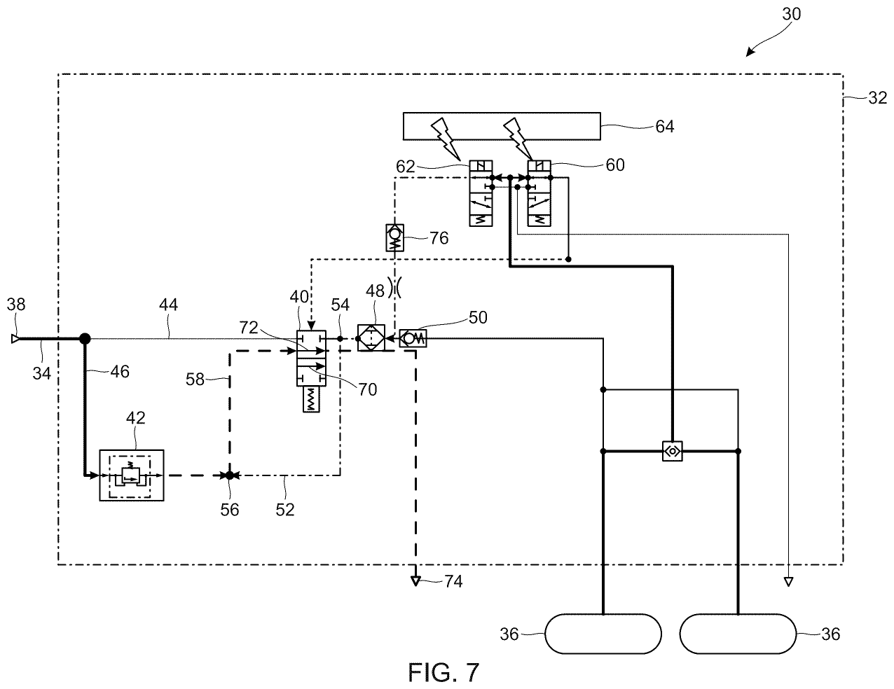

FIG. 7 illustrates a mode of operation in which the first valve 40 is in the first state and in which pressurized air from the air tanks 36 is provided to the filter 48 to regenerate the filter 48. Thus, in FIG. 7 the processing circuitry 64 has not only caused the first energizable valve device 60 to become energized, which in turn has caused the first valve 40 to be in said first state, but the processing circuitry 64 has also caused the second energizable valve device 62 to become energized. When the second energizable valve device 62 becomes energized, pressurized air that is present in a volume between the air tanks 36 and the second energizable valve device 62 is allowed to pass through the second energizable valve device 62 and reach the filter 48 so as to regenerate the filter 48. After passing through the second energizable valve device 62 the pressurized air may pass through a second-check valve 76 before passing through and regenerating the filter 48. After having passed through the filter 48, the pressurized air will flow along the bypass passage 52 and the air passage 58 and then via the first valve 40 to the ambient atmosphere. The compressor may, as illustrated in FIG. 7, be running during regeneration of the filter 48 (e.g. to maintain a temperature for counteracting condensation in the compressor), or it may be turned off (e.g. if temperature in compressor is high enough).

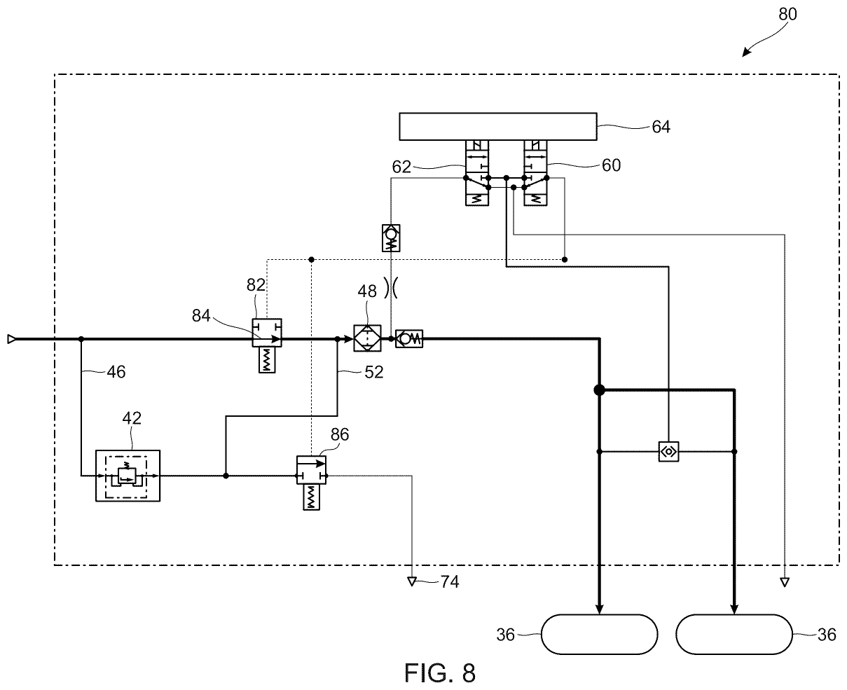

FIGS. 8-11 illustrate schematically a pneumatic system 80 according to at least another example of this disclosure; wherein different operating modes of the pneumatic system are illustrated. A difference between the example in FIGS. 8-11 compared to the example in FIGS. 4-7 is that in FIGS. 8-11, the first valve 82 only has one channel 84 and that the fluid communication to the ambient environment goes via a third valve 86 (instead of going via the second channel 72 of the first valve 40 as in FIGS. 4-7). M ore specifically, the pneumatic system 80 in the example of FIGS. 8-11 further comprises the third valve 86 arranged between the second valve 42 and an outlet (exhaust port 74) to the ambient environment. The third valve 86 has an open state in which air is allowed to flow through the third valve 86 to the ambient environment, and a closed state in which air is prevented from flowing through the third valve 86 to the ambient environment.

Thus, in FIG. 8, which illustrates a corresponding mode of operation as FIG. 4, the first valve 82 is in its second state, allowing air to flow through the first valve 82 to the air tanks 36. The third valve 86 is closed, preventing passing of air to the ambient environment. The first and second energizable valve devices 60, 62 are not energized.

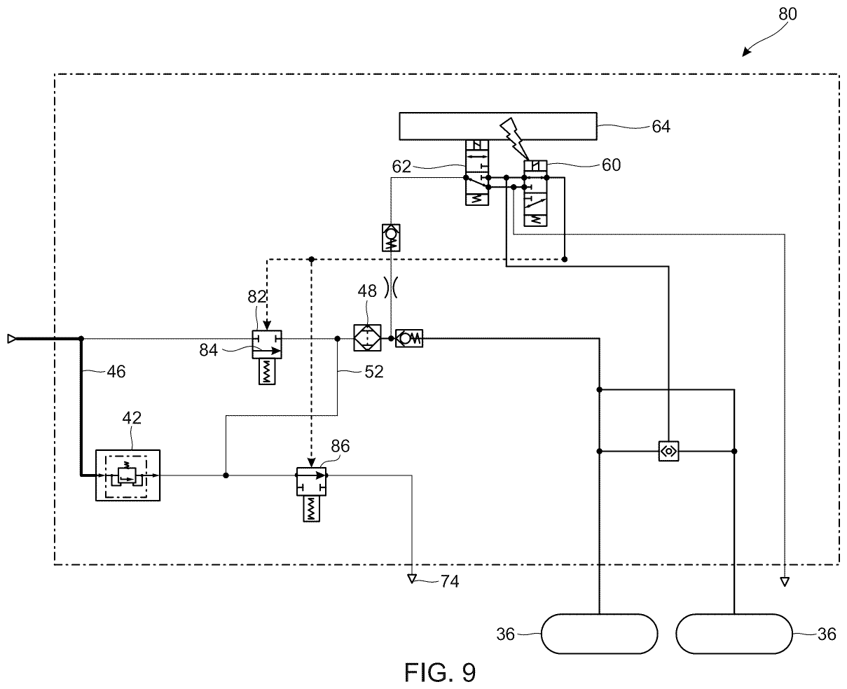

In FIG. 9, which illustrates a corresponding mode of operation as FIG. 5, the first energizable valve device 60 has become energized, and therefore the first valve 82 has moved to its first state in which it prevents air from passing to the air tanks 36. The pressurized air that goes through the first energizable valve device 60 is not only used for changing the state of the first valve 82 but also to changing the state of the third valve 86. The third valve 86 which is normally closed, e.g. being spring biased, has now become opened due to the pressurized air that has passed through the first energizable valve device 60.

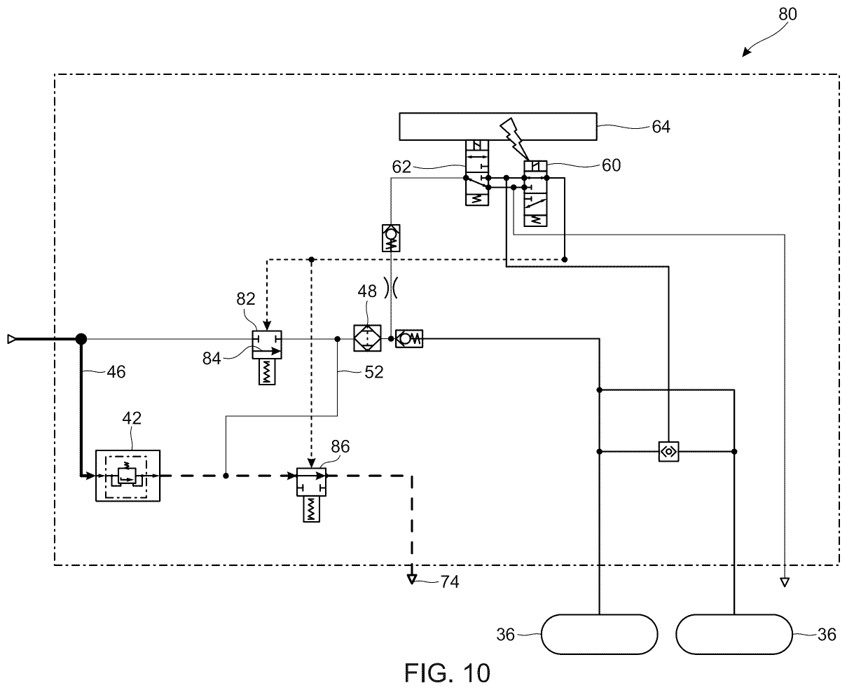

In FIG. 10, which illustrates a corresponding mode of operation as FIG. 6, the pressure in the second branch 46 is high enough to open the second valve 42 to allow pressurized air to pass through the second valve 42 and then through the third valve 86 to the ambient environment.

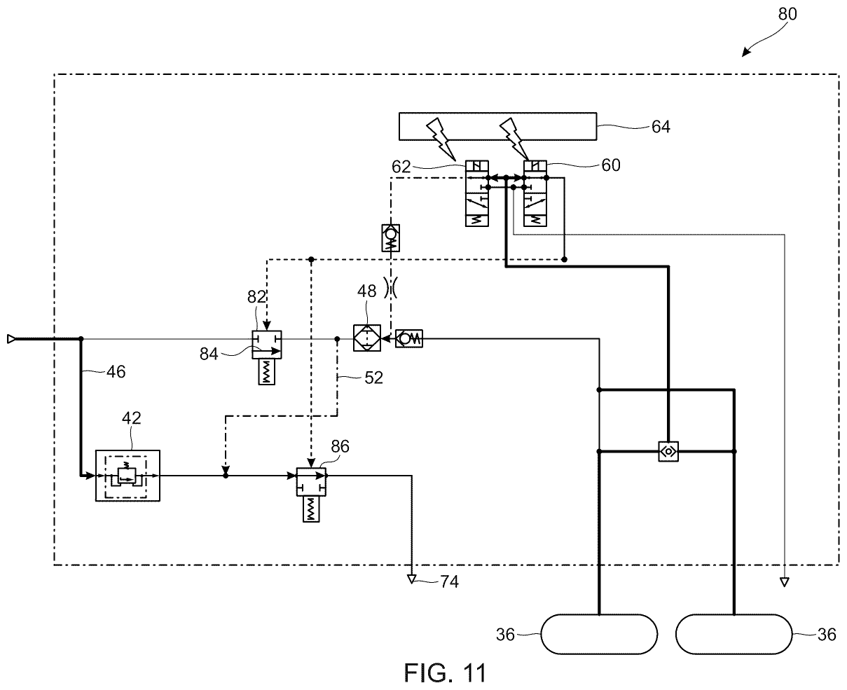

In FIG. 11, which illustrates a corresponding mode of operation as FIG. 7, the second energizable valve device 62 has also become energized, allowing pressurized air to pass through the second energizable valve device 62 to regenerate the filter 48 and then let the air pass through via the bypass passage 52 and the air passage through the third valve 86 to the ambient environment.

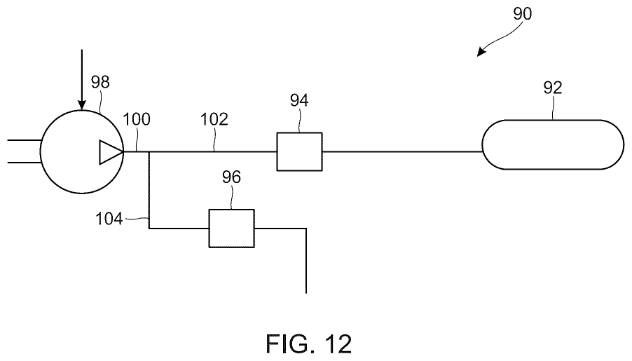

FIG. 12 is a further schematic illustration of a pneumatic system 90 according to at least one example of this disclosure. The pneumatic system 90 comprises:
an air tank 92
a first valve 94,
a second valve 96, and
an air compressor 98 configured to provide air from an output of the air compressor 98 for pressurizing the air tank 92, wherein a flow passage 100 extending from the output of the air compressor 98 is bifurcated such that a first branch 102 of the flow passage 100 extends to the first valve 94 and a second branch 104 of the flow passage 100 extends to the second valve 96,
wherein the first valve 94 is configured to control air flow from the output of the air compressor 98 to the air tank 92, wherein the first valve 94 has a first state in which air is prevented from passing from the output of the air compressor 98 to the air tank 92 via the first valve 94, and has a second state in which air is allowed to pass from the output of the air compressor 98 to the air tank 92 via the first valve 94,
wherein the pneumatic system 90 is operable in a first mode of operation in which the first valve 94 is in said first state,
wherein, in said first mode of operation of the pneumatic system 90, the second valve 96 is configured to control air flow from the output of the air compressor 98 to ambient environment, the second valve 96 having a closed state in which air is prevented from passing from the output of the air compressor 98 to the ambient environment via the second valve 96, and an open state in which air is allowed to pass from the output of the air compressor 98 to the ambient environment via the second valve 96,
wherein the second valve 96 is configured to change to, or remain in, said open state when the pressure of the air in said second branch 104 is higher than a predetermined threshold, and to change to, or remain in, said closed state when the pressure of the air in the second branch 104 is lower than the predetermined threshold.
Example 1: A pneumatic system for a vehicle, comprising:
an air tank,
a first valve,
a second valve, and
an air compressor configured to provide air from an output of the air compressor for pressurizing the air tank, wherein a flow passage extending from the output of the air compressor is bifurcated such that a first branch of the flow passage extends to the first valve and a second branch of the flow passage extends to the second valve,
wherein the first valve is configured to control air flow from the output of the air compressor to the air tank, wherein the first valve has a first state in which air is prevented from passing from the output of the air compressor to the air tank via the first valve, and has a second state in which air is allowed to pass from the output of the air compressor to the air tank via the first valve,
wherein the pneumatic system is operable in a first mode of operation in which the first valve is in said first state,
wherein, in said first mode of operation of the pneumatic system, the second valve is configured to control air flow from the output of the air compressor to ambient environment, the second valve having a closed state in which air is prevented from passing from the output of the air compressor to the ambient environment via the second valve, and an open state in which air is allowed to pass from the output of the air compressor to the ambient environment via the second valve,
wherein the second valve is configured to change to, or remain in, said open state when the pressure of the air in said second branch is higher than a predetermined threshold, and to change to, or remain in, said closed state when the pressure of the air in the second branch is lower than the predetermined threshold.
Example 2: The pneumatic system of example 1, wherein the pneumatic system is operable in a second mode of operation in which the first valve is in the second state and in which the air tank becomes loaded with pressurized air supplied from the output of the air compressor via the first valve.
Example 3: The pneumatic system of any of examples 1-2, further comprising a filter located downstream of the first valve such that in the second state of the first valve, air that passes from the output of the air compressor to the air tank via the first valve, also passes through the filter after it has passed through the first valve, before the air reaches the air tank.
Example 4: The pneumatic system of example 3, wherein the pneumatic system is operable in a third mode of operation in which the first valve is in the first state and in which pressurized air from the air tank is provided to the filter to regenerate the filter.
Example 5: The pneumatic system of any of examples 1-4, further comprising:
a first energizable valve device,
a second energizable valve device, and
processing circuitry configured to set a current mode of operation of the pneumatic system by selectively energizing the first and second valve devices
Example 6: The pneumatic system of example 5, wherein the air tank has a cut-off pressure, wherein when the air pressure in the air tank reaches the cut-off pressure, the processing circuitry energizes the first energizable valve device, thereby allowing pressurized air that is present in a volume between the air tank and the first energizable valve device to pass through the first energizable valve device and reach the first valve so as to pneumatically activate the first valve to change to its first state.
Example 7: The pneumatic system of any of examples 5-6 when dependent on example 4, wherein in order to set the pneumatic system in said third mode of operation, the processing circuitry is configured to energize the second energizable valve device, thereby allowing pressurized air that is present in a volume between the air tank and the second energizable valve device to pass through the second energizable valve device and reach the filter so as to regenerate the filter in said third mode of operation.
Example 8: The pneumatic system of example 7, wherein in order to set the pneumatic system in said third mode of operation, the processing circuitry is also configured to energize the first energizable valve device to allow pressurized air to pass through the first energizable valve device to pneumatically activate the first valve to change to its first state.
Example 9: The pneumatic system of any of examples 1-8, wherein the first valve comprises a first channel and a second channel, wherein in said first state of the first valve:
the first channel is closed to prevent air from passing from the output of the air compressor to the air tank via the first valve, and
the second channel is open to allow air that has passed from the output of the air compressor and through the second valve to then also pass through the second channel of the first valve before reaching the ambient environment.
Example 10: The pneumatic system of example 9, wherein in said second state of the first valve:
the first channel is open to allow air to pass from the output of the air compressor, through the first channel of the first valve, to the air tank, and
the second channel is closed to prevent air from passing from the second valve, through the first valve, to the ambient environment.
Example 11: The pneumatic system of any of examples 1-8, further comprising a third valve arranged between the second valve and an outlet to the ambient environment, the third valve having an open state in which air from the second valve is allowed to flow through the third valve to the ambient environment, and a closed state in which air from the second valve is prevented from flowing through the third valve to the ambient environment, wherein, in said first mode of operation of the pneumatic system, the third valve is in its open state.
Example 12: The pneumatic system of any of examples 1-11, wherein the air compressor is an oil-lubricated air compressor.
Example 13: The pneumatic system of any of examples 1-12, further comprising an air dryer located downstream of the air compressor and upstream of the air tank, wherein the first valve and the second valve are integrated in the air dryer.
Example 14: The pneumatic system of example 3 or any one of examples 4-13 when dependent on example 3, the pneumatic system further comprising a bypass passage which allows for fluid communication between a first point and a second point, wherein the first point is located in an air passage between the first valve and the filter, and wherein the second point is located in an air passage between the second valve and the first valve.
Example 15: The pneumatic system of any one of examples 1-14, wherein the first valve is spring-biased towards the second state.
Example 16: The pneumatic system of any one of examples 1-15, wherein the second valve is spring-biased towards the closed state.
Example 17: The pneumatic system of example 3 or any one of examples 4-16 when dependent on example 3, further comprising a check-valve, wherein the filter is located between the first valve and the check-valve, wherein the check-valve allows air to flow from the filter through the check valve to the air tank, but prevents air flow in the opposite direction.
Example 18: The pneumatic system of example 17 when dependent on example 5, wherein said check-valve is a first check-valve, the pneumatic system further comprising a second check-valve, wherein the second check-valve is located in an air passage extending from the second energizable valve device to a point located between the filter and the first check-valve.
Example 19: The pneumatic system of any of examples 1-18, further comprising:
a first air passage extending from the output of the air compressor to the first valve,
a second air passage extending from the first valve to the air tank,
a third air passage extending from the output of the air compressor to the second valve,
a fourth air passage extending from the second valve to the first valve,
a fifth air passage extending from the first valve to the ambient environment,
wherein pressurized air passes said first air passage and said second air passage on its way from the output of the compressor to the air tank, and wherein air passes said fourth air passage and said fifth air passage on its way from the second valve to the ambient environment.
Example 20: A vehicle comprising the pneumatic system according to any of examples 1-19.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A pneumatic system for a vehicle, comprising:
an air tank,
a first valve,
a second valve, and
an air compressor configured to provide air from an output of the air compressor for pressurizing the air tank, wherein a flow passage extending from the output of the air compressor is bifurcated such that a first branch of the flow passage extends to the first valve and a second branch of the flow passage extends to the second valve,
wherein the first valve is configured to control air flow from the output of the air compressor to the air tank, wherein the first valve has a first state in which air is prevented from passing from the output of the air compressor to the air tank via the first valve, and has a second state in which air is allowed to pass from the output of the air compressor to the air tank via the first valve,
wherein the pneumatic system is operable in a first mode of operation in which the first valve is in said first state,
wherein, in said first mode of operation of the pneumatic system, the second valve is configured to control air flow from the output of the air compressor to ambient environment, the second valve having a closed state in which air is prevented from passing from the output of the air compressor to the ambient environment via the second valve, and an open state in which air is allowed to pass from the output of the air compressor to the ambient environment via the second valve,
wherein the second valve is configured to change to, or remain in, said open state when the pressure of the air in said second branch is higher than a predetermined threshold, and to change to, or remain in, said closed state when the pressure of the air in the second branch is lower than the predetermined threshold.

2. The pneumatic system of claim 1, wherein the pneumatic system is operable in a second mode of operation in which the first valve is in the second state and in which the air tank becomes loaded with pressurized air supplied from the output of the air compressor via the first valve.

3. The pneumatic system of claim 1, further comprising a filter located downstream of the first valve such that in the second state of the first valve, air that passes from the output of the air compressor to the air tank via the first valve, also passes through the filter after it has passed through the first valve, before the air reaches the air tank.

4. The pneumatic system of claim 3, wherein the pneumatic system is operable in a third mode of operation in which the first valve is in the first state and in which pressurized air from the air tank is provided to the filter to regenerate the filter.

5. The pneumatic system of claim 1, further comprising:
a first energizable valve device,
a second energizable valve device, and
processing circuitry configured to set a current mode of operation of the pneumatic system by selectively energizing the first and second valve devices.

6. The pneumatic system of claim 5, wherein the air tank has a cut-off pressure, wherein when the air pressure in the air tank reaches the cut-off pressure, the processing circuitry energizes the first energizable valve device, thereby allowing pressurized air that is present in a volume between the air tank and the first energizable valve device to pass through the first energizable valve device and reach the first valve so as to pneumatically activate the first valve to change to its first state.

7. The pneumatic system of claim 5, wherein in order to set the pneumatic system in said third mode of operation, the processing circuitry is configured to energize the second energizable valve device, thereby allowing pressurized air that is present in a volume between the air tank and the second energizable valve device to pass through the second energizable valve device and reach the filter so as to regenerate the filter in said third mode of operation.

8. The pneumatic system of claim 7, wherein in order to set the pneumatic system in said third mode of operation, the processing circuitry is also configured to energize the first energizable valve device to allow pressurized air to pass through the first energizable valve device to pneumatically activate the first valve to change to its first state.

9. The pneumatic system of claim 1, wherein the first valve comprises a first channel and a second channel, wherein in said first state of the first valve:
the first channel is closed to prevent air from passing from the output of the air compressor to the air tank via the first valve, and
the second channel is open to allow air that has passed from the output of the air compressor and through the second valve to then also pass through the second channel of the first valve before reaching the ambient environment.

10. The pneumatic system of claim 9, wherein in said second state of the first valve:
the first channel is open to allow air to pass from the output of the air compressor, through the first channel of the first valve, to the air tank, and
the second channel is closed to prevent air from passing from the second valve, through the first valve, to the ambient environment.

11. The pneumatic system of claim 1, further comprising a third valve arranged between the second valve and an outlet to the ambient environment, the third valve having an open state in which air from the second valve is allowed to flow through the third valve to the ambient environment, and a closed state in which air from the second valve is prevented from flowing through the third valve to the ambient environment, wherein, in said first mode of operation of the pneumatic system, the third valve is in its open state.

12. The pneumatic system of claim 1, wherein the air compressor is an oil-lubricated air compressor.

13. The pneumatic system of claim 1, further comprising an air dryer located downstream of the air compressor and upstream of the air tank, wherein the first valve and the second valve are integrated in the air dryer.

14. The pneumatic system of claim 3, further comprising a bypass passage which allows for fluid communication between a first point and a second point, wherein the first point is located in an air passage between the first valve and the filter, and wherein the second point is located in an air passage between the second valve and the first valve.

15. The pneumatic system of claim 1, wherein the first valve is spring-biased towards the second state.

16. The pneumatic system of claim 1, wherein the second valve is spring-biased towards the closed state.

17. The pneumatic system of claim 3, further comprising a check-valve, wherein the filter is located between the first valve and the check-valve, wherein the check-valve allows air to flow from the filter through the check valve to the air tank, but prevents air flow in the opposite direction.

18. The pneumatic system of claim 17, wherein said check-valve is a first check-valve, the pneumatic system further comprising a second check-valve, wherein the second check-valve is located in an air passage extending from the second energizable valve device to a point located between the filter and the first check-valve.

19. The pneumatic system of claim 1, further comprising:
a first air passage extending from the output of the air compressor to the first valve,
a second air passage extending from the first valve to the air tank,
a third air passage extending from the output of the air compressor to the second valve,
a fourth air passage extending from the second valve to the first valve,
a fifth air passage extending from the first valve to the ambient environment,
wherein pressurized air passes said first air passage and said second air passage on its way from the output of the compressor to the air tank, and wherein air passes said fourth air passage and said fifth air passage on its way from the second valve to the ambient environment.

20. A vehicle comprising the pneumatic system according to claim 1.
